(19) United States
(12) Patent Application Publication
(10) Pub. No.: US 2024/0011863 A1
(43) Pub. Date: Jan. 11, 2024

(54) METHODOLOGY AND GRAPHICAL USER INTERFACE FOR NDE/SHM USING TWO-STAGE COMPRESSIVE SENSING

(71) Applicants: UNIVERSITY OF SOUTH CAROLINA, COLUMBIA, SC (US); ADVENT INNOVATIONS LTD. CO., COLUMBIA, SC (US)

(72) Inventors: SOURAV BANERJEE, IRMO, SC (US); MUSTAHSEEN M. INDALEEB, WEST COLUMBIA, SC (US); SHAWN BEARD, BISHOP, CA (US); RITUBARNA BANERJEE, COLUMBIA, SC (US)

(21) Appl. No.: 18/311,359

(22) Filed: May 3, 2023

Related U.S. Application Data
(60) Provisional application No. 63/359,404, filed on Jul. 8, 2022.
(60) Provisional application No. 63/488,618, filed on Mar. 6, 2023.

(51) Int. Cl. G01M 5/00

(52) U.S. Cl. CPC G01M 5/0033; G01M 5/0066

(57) ABSTRACT

The disclosure deals with a system and method for Compressive Sensing, which has been shown to greatly reduce data acquisition and processing burdens by providing mathematical guarantees for accurate signal recovery from far fewer samples than conventionally needed. A generalized Compressive Sensing methodology developed for automated reduction of non-destructive evaluation/structural health monitoring (NDE/SHM) data is effective for multiple types of NDE/SHM systems. The methodology uses Compressive Sensing at two stages in the data acquisition and analysis process to detect damage. The two stages are: (1) temporally undersampled sensor signals from (2) spatially undersampled sensor arrays, resulting in faster data acquisition and reduced data sets without any loss in damage detection ability. In addition, a graphical user interface helps guide and visualize the associated data reconstruction process.

### PRIORITY CLAIM

The present application claims the benefit of priority of U.S. Provisional Patent Application No. 63/359,404, filed Jul. 8, 2022, and the benefit of priority of U.S. Provisional Patent Application No. 63/488,618, filed Mar. 6, 2023, both of which are titled Methodology and Graphical User Interface for NDE/SHM Using Two-Stage Compressive Sensing, and both of which are fully incorporated herein by reference for all purposes.

### STATEMENT REGARDING FEDERALLY SPONSORED RESEARCH OR DEVELOPMENT

This invention was made with government support under Grant No. 80NSSC20C0200, awarded by the National Aeronautics and Space Administration (NASA). The government has certain rights in the invention.

### BACKGROUND OF PRESENTLY DISCLOSED SUBJECT MATTER

The disclosure deals with a system and method for a generalized Compressive Sensing methodology developed for automated reduction of non-destructive evaluation/structural health monitoring (NDE/SHM) data for multiple types of NDE/SHM systems.

Currently, NASA is developing new spacecraft for human space flight, particularly focusing on extended periods of time in space/orbit. Many of these vehicles are targeted for long-term use, which presents specific challenges for inspection and maintenance. While in orbit, in space transit, or even on the Moon or Mars, the use of traditional NDE is prohibitive because of location and inaccessibility. Infrequent inspection can lead to conservative, high weight designs. NASA is seeking technologies to facilitate inspections on large, complex structures and to provide reliable assessments of structural health.

Structural health monitoring (SHM) can help overcome inspection difficulties and has shown good results on small structures. However, transition of such technology to large and/or complex structures has been slow. Some reasons for the slow adoption are difficulties with large sensor arrays, timely analysis of large data sets, and overall weight of the system. In order to realize the benefits of SHM, there's a need to reduce the number of sensors and to minimize data acquisition processes, while maintaining the ability to accurately detect, locate, and characterize damage.

### SUMMARY OF PRESENTLY DISCLOSED SUBJECT MATTER

Disclosed is a generalized Compressive Sensing methodology developed for automated reduction of non-destructive evaluation/structural health monitoring (NDE/SHM) data for multiple types of NDE/SHM systems.

The methodology uses Compressive Sensing at two stages in the data acquisition and analysis process (data reconstruction) to detect damage: (1) temporally undersampled sensor signals from (2) spatially undersampled sensor arrays, resulting in faster data acquisition and reduced data sets without any loss in damage detection ability. Some embodiments may include using a developed graphical user interface to help guide and visualize the data reconstruction process.

While generally relating to the category of mechanical-based innovation, some of the specific areas of interest, among others, may relate to NDE, SHM, Compressive Sensing, Data Reduction, Ultrasonics, and Data Features.

Compressive Sensing has been shown to greatly reduce data acquisition and processing burdens by providing mathematical guarantees for accurate signal recovery from far fewer samples than conventionally needed. A generalized Compressive Sensing methodology has been developed for automated reduction of NDE/SHM data for multiple types of NDE/SHM systems. The presently disclosed methodology uses Compressive Sensing at two stages in the data acquisition and analysis process to detect damage. The two stages are: (1) temporally undersampled sensor signals from (2) spatially undersampled sensor arrays, resulting in faster data acquisition and reduced data sets without any loss in damage detection ability. In addition, a graphical user interface has been developed to help guide and visualize the data reconstruction process.

Additionally, the disclosed technology includes the following novel features: (1) the ability to generate basis functions needed for Compressive Sensing; (2) the ability to reconstruct temporally undersampled sensor signals from different types of NDE/SHM techniques; (3) the ability to reconstruct parameters from spatially undersampled actuator-sensor paths and/or pixels from images; (4) the ability to generate diagnostic images from the reconstructed data in both time and space; (5) the ability to import and analyze sensor signals from various NDE/SHM techniques and in various data formats; and (6) the ability to quantify the signal/image reconstructions through the use of correlation coefficients and probability-of-detection (POD) curves. The advantages of the innovation are the reduction in data acquisition processes and storage, and the potential to reduce the number of required sensors and total weight of NDE/SHM systems.

It is anticipated that the first application of the technology will be its integration into NASA's inspection tools for large complex space structures made with composites or thin metals, such as the Orion Crew Module, the Space Launch System (SLS), and the Lunar Outpost Platform-Gateway. As NASA continues to direct efforts into deep space flight, smart structures that are instrumented with SHM systems will be needed to provide real-time mission critical information of the structure's status. In order for these SHM systems to be viable, the total number of sensors, total weight, and data acquisition requirements must be minimized, and the Compressive Sensing methodology will be critical in achieving this.

If the Compressive Sensing methodology is applied, almost all aerospace manufacturing companies who perform NDE and SHM to certify their material will use the presently disclosed technology. Anticipated market in the next 3 to 5 years is $3-5 million, with FAA approval after 10 years, $1-3 billion. In addition to aerospace manufacturing (aircraft wings and fuselage), industries including marine (ship hulls), wind energy (rotor blades), railways, civil infrastructure (buildings and bridges), oil and gas (pipelines), etc. would benefit from this innovation. Generally, any industry that uses large structures that require frequent inspection will benefit from the use of the Compressive Sensing technology.

It is to be understood that the presently disclosed subject matter equally relates to associated and/or corresponding methodologies. One exemplary such method is for generalized compressive sensing process for automated reduction of non-destructive evaluation/structural health monitoring (NDE/SHM) data, for use with different types of NDE/SHM systems, for accurate signal recovery based on fewer samples than a full sampling of NDE/SHM data from a target structure. Such method preferably comprises obtaining undersampled data by conducting data acquisition relative to a target structure for NDE/SHM; using compressive sensing to reconstruct the undersampled data from data acquisition relative to a target structure for NDE/SHM; and analyzing the reconstructed undersampled data to detect structural damage in the target structure.

Another exemplary such method comprises methodology for non-destructive evaluation/structural health monitoring (NDE/SHM) of structures based on pitch-catch ultrasonic guided waves, using a degree of data acquisition from a target structure that is relatively reduced from what is required for a full sampling of the target structure, while maintaining the ability to accurately detect, locate, and characterize damage to the target structure. Such methodology preferably comprises obtaining a set of undersampled sensor signals from undersampled actuator-sensor paths of the target structure; subjecting the set of sensor signals to a first stage of compressive sensing to reconstruct temporally undersampled sensor signals; subjecting the set of sensor signals to a second stage of compressive sensing to reconstruct spatially undersampled actuator-sensor paths; and analyzing the reconstructed sensor signals and reconstructed spatially undersampled actuator-sensor paths to detect any structural damage to the target structure.

Other example aspects of the present disclosure are directed to systems, apparatus, tangible, non-transitory computer-readable media, user interfaces, memory devices, and electronic devices for Compressive Sensing technology. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a non-destructive evaluation/structural health monitoring (NDE/SHM) system for generalized compressive sensing process for automated reduction of non-destructive evaluation/structural health monitoring (NDE/SHM) data, for use with different types of NDE/SHM data, for accurate signal recovery based on fewer samples than a full sampling of NDE/SHM data from a target structure. Such system preferably comprises a plurality of sensors for data acquisition relative to a target structure; and one or more tangible, non-transitory computer-readable media that collectively store instructions that, when executed, cause a computing device comprising one or more processors to perform operations, the operations comprising obtaining undersampled data by conducting data acquisition relative to a target structure for NDE/SHM; using compressive sensing to reconstruct the undersampled data from data acquisition relative to a target structure for NDE/SHM; and analyzing the reconstructed undersampled data to detect structural damage in the target structure.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in any summarized objects herewith, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a conceptual diagram of a pitch-catch, ultrasonic guided-wave structural health monitoring (SHM) system in accordance with presently disclosed exemplary subject matter;

FIG. 2 illustrates a representative diagram of presently disclosed methodology for application to ultrasonic guided waves broken down into four modules as shown in FIG. 2;

FIG. 3 illustrates an exemplary diagram of how presently disclosed non-destructive evaluation/structural health monitoring (NDE/SHM) dataflow has been designed to distinguish between datasets that have been undersampled in both time and space from those that have been undersampled in either time or space, in accordance with presently disclosed subject matter;

FIGS. 4(a) and 4(b) represent respective images of a graphical user interface (GUI) developed along with software modules to implement the Compressive Sensing methodology and algorithms presently disclosed, with the GUI shown able to import and analyze sensor signals from various NDE/SHM techniques and in various data formats;

FIG. 5 graphically illustrates example probability-of-detection (POD) curves for compression ratio (CR) values of 25%, 20%, and 10%, with values corresponding for example Z-scan data, and with generated POD curves before any Compressive Sensing reconstruction of the data in accordance with presently disclosed subject matter; and

FIG. 6 graphically illustrates example probability-of-detection (POD) curves, similar to those illustrated per FIG. 5, for compression ratio (CR) values of 25%, 20%, and 10%, with values corresponding for example Z-scan data, and with generated POD curves after Compressive Sensing reconstruction of the data in accordance with presently disclosed subject matter.

Repeat use of reference characters in the present specification and drawings is intended to represent the same or analogous features, elements, or steps of the presently disclosed subject matter.

### DETAILED DESCRIPTION OF PRESENTLY DISCLOSED SUBJECT MATTER

Reference will now be made in detail to various embodiments of the disclosed subject matter, one or more examples of which are set forth herein. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

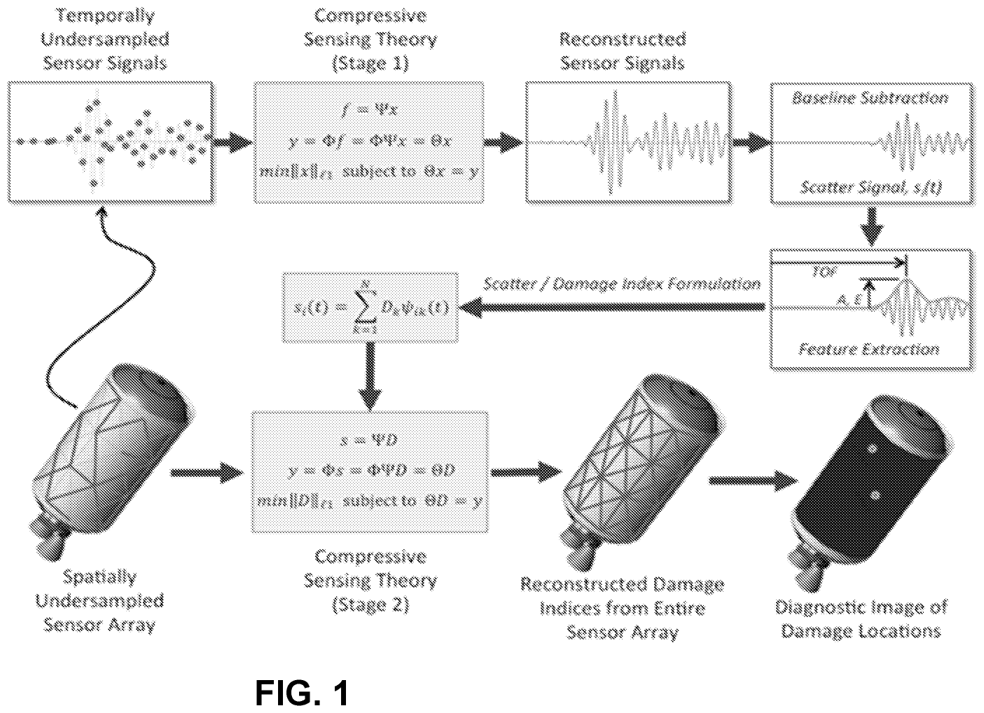

The presently disclosed methodology can be used to reduce data acquisition processes and data storage burdens for non-destructive evaluation/structural health monitoring (NDE/SHM) systems while maintaining the ability to accurately detect, locate, and characterize structural damage. The methodology uses Compressive Sensing to reconstruct data at two stages in the data acquisition and to analyze the process to detect damage and generate a diagnostic image of the structure. Data is reconstructed at two stages: (1) temporally undersampled sensor signals from (2) spatially undersampled sensor arrays. FIG. 1 illustrates a conceptual diagram of a pitch-catch, ultrasonic guided-wave structural health monitoring (SHM) system in accordance with presently disclosed exemplary subject matter.

In the FIG. 1 diagram, the top row depicts the Stage 1, where temporally undersampled signals are reconstructed using Compressive Sensing. The reconstructed signals are then analyzed, and features are extracted to provide inputs into Stage 2, which is depicted in the bottom row. In Stage 2, spatially undersampled sensor data (from missing actuator-sensor paths) are reconstructed to generate a diagnostic image of the structure.

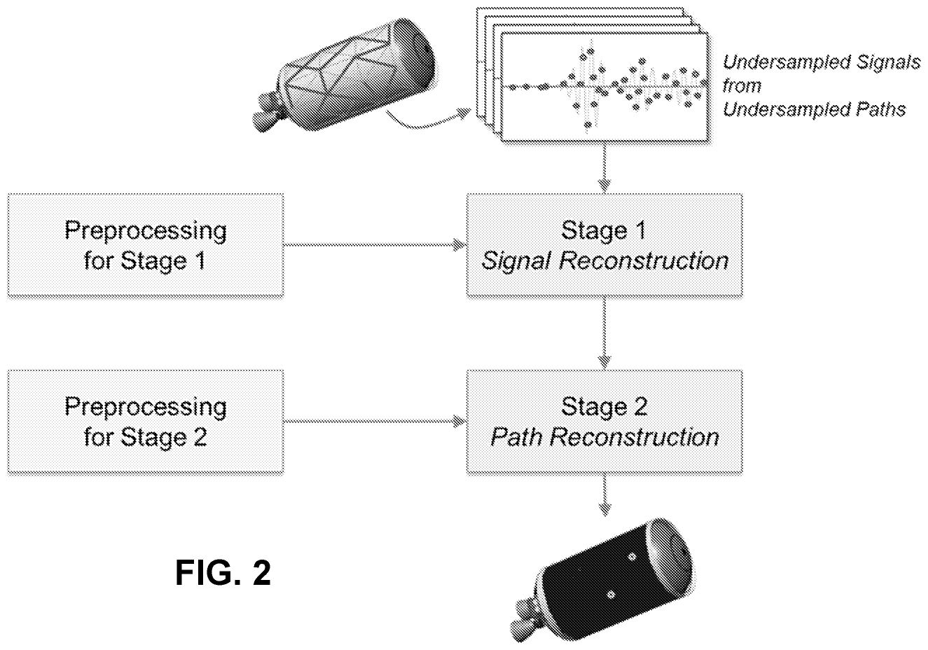

The initial methodology for application to ultrasonic guided waves was broken down into four modules as shown in the representative exemplary diagram of FIG. 2. In other words, FIG. 2 illustrates a representative diagram of presently disclosed methodology for application to ultrasonic guided waves broken down into four modules as shown in FIG. 2. The preprocessing modules are intended to be run only once in order to generate the basis functions required for the Compressive Sensing algorithms that are housed in the Stage 1 and Stage 2 modules. The Stage 1 Signal Reconstruction module contains Compressive Sensing algorithms to enable reconstruction of temporally undersampled sensor signals. The Stage 2 Path Reconstruction module contains Compressive Sensing algorithms for reconstruction of spatially undersampled actuator-sensor paths.

While the initial Compressive Sensing methodology was focused on reducing the data requirements for pitch-catch ultrasonic guided waves, the software architecture design allows it to be extended to other NDE/SHM techniques. The representative modular software architecture design has been built upon and expanded to include other NDE/SHM techniques.

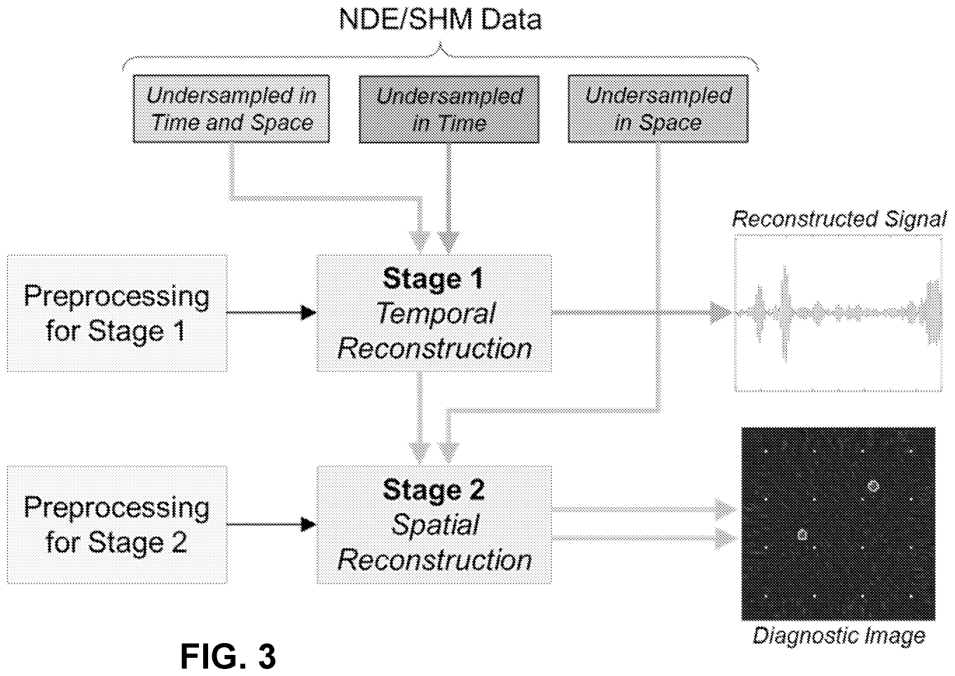

Not all NDE/SHM methods will generate data that can be undersampled in both time and space. Therefore, to generalize the architecture to accommodate other types of NDE/SHM methods, the stages have been redefined to be Stage 1 Temporal Reconstruction and Stage 2 Spatial Reconstruction. Also, the NDE/SHM dataflow has been designed to distinguish between datasets that have been undersampled in both time and space from those that have been undersampled in either time or space, as represented by the exemplary FIG. 3 diagram. In other words, FIG. 3 illustrates an exemplary diagram of how presently disclosed non-destructive evaluation/structural health monitoring (NDE/SHM) dataflow has been designed to distinguish between datasets that have been undersampled in both time and space from those that have been undersampled in either time or space, in accordance with presently disclosed subject matter. For example, data that has been undersampled in both space and time (e.g., the pitch-catch data) will flow through both Stage 1 and Stage 2 as shown by the time-and-space arrows in the figure. NDE data that has been undersampled in time only (e.g., pulse-echo/A-scan or acoustic emission data) will just flow through Stage 1 to reconstruct the signals as shown by the time arrows. Similarly, data that has been undersampled in space only (e.g., C-scan data) will bypass Stage 1 and go directly to Stage 2 to reconstruct the data for imaging as shown by the space arrows.

The architecture and methodologies enable data reconstruction capabilities for various NDE/SHM techniques, including pitch-catch ultrasonic guided waves, pulse-echo (A-scan), B-scan, C-scan, Z-scan, acoustic emission, impact data, thermography, etc.

As before, the pre-processing modules for Stage 1 and Stage 2 are intended to be run only once for each application. Their purpose is to determine the best basis functions to use for a particular type of NDE/SHM data to accurately reconstruct the data in time (Stage 1) and/or space (Stage 2).

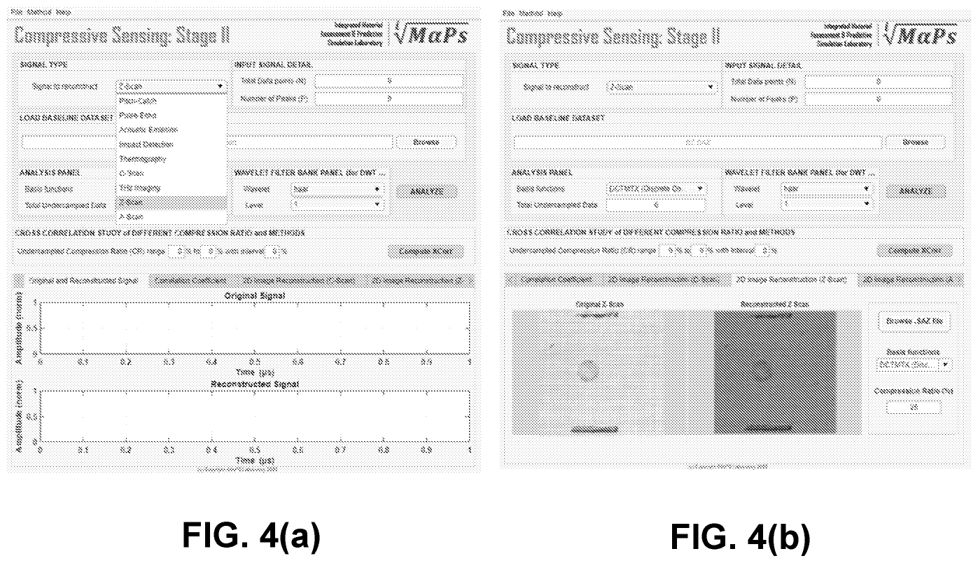

Software modules and a graphical user interface (GUI) have been developed to implement the Compressive Sensing methodology and algorithms. The GUI shown in representative FIGS. 4(a) and 4(b) can import and analyze sensor signals from various NDE/SHM techniques and in various data formats, such as *.mat, *.txt, *.csv, *.dat, and *.saz data files from A-scans, C-scans, and Z-scans. In other words, FIGS. 4(a) and 4(b) represent respective images of a graphical user interface (GUI) developed along with software modules to implement the Compressive Sensing methodology and algorithms presently disclosed, with the GUI shown able to import and analyze sensor signals from various NDE/SHM techniques and in various data formats.

In addition to the Compressive Sensing algorithms and software, methodologies to quantity the signal/image reconstruction have been developed. Previously, signal reconstruction and diagnostic image reconstruction abilities have been quantified through correlation coefficients. The quantification metrics have been expanded by developing a methodology to generate probability-of-detection (POD) curves as a function of compression ratio (CR), and the subsequent correlation coefficient (r) after reconstruction to quantify accuracy of damage detection from undersampled data.

The objective is to demonstrate that using fewer sensors or fewer sample points per measurement (CR<100%) can result in the same, or nearly the same, damage detection capabilities as fully sampled cases. In traditional sensing, using fewer sensors or fewer sample points per measurement tends to flatten and move the POD curves to the right. However, the use of Compressive Sensing to reconstruct the undersampled data can restore the damage detection capabilities which will move the POD curves back toward the fully sampled cases.

There are many influencing factors that affect POD including, but not limited to, the intrinsic capability of a given NDE/SHM method (e.g., physical process of signal detection of waves/rays from a material defect); damage type, size, and orientation; structural geometry and accessibility; environment (e.g., temperature, humidity, vibration); and human factors (e.g., inspector experience, inspection procedures, organizational protocol). In addition, there are many different methodologies/formulations for generating POD curves, depending on the application.

The goal of the developed methodology is to generalize the procedure for estimating the POD and make it applicable to all NDE/SHM methods that use Compressive Sensing to reconstruct undersampled data. The methodology starts by representing the POD for the undersampled case (before CS reconstruction), POD′, as a function of the original fully sampled POD_{f} per Eq. 1:

PODᵤ(a)=POD_{f}(a′), where a′=C₁(a−C₂) (Eq. 1)

Per Eq. 1, a is the defect size, and a′ is a modified detectable defect size due to undersampling of the inspection data. C₁ represents a scaling of the detectable damage size, and a change in value will shift and skew the POD curve. C₂ represents a constant jump in the detectable damage size, and a change in value will result in a pure shift of the POD curve to the left or the right.

This generalized equation Eq. 1 for a′ can be simplified by noting that both undersampling in time (Stage 1 CS) and undersampling in space (Stage 2 CS) will result in a scaling of the detectable damage size rather than a constant jump. For example, for the case of a combined A-scan/C-scan from a composite plate with induced debonds/delaminations, the CR is defined by Eq. 2 as:

$$CR = \frac{m \times k}{N \times P} \times 100 \% \qquad ( Eq . 2 )$$

where m is the number of temporally undersampled signal points in each A-scan, N is the full signal length of each A-scan, k is the number of spatially undersampled pixels in the C-scan, and P is the full number of pixels in the C-scan. Note that CR=100% for fully sampled data and less than 100% for undersampled data in both time and space.

From geometry, undersampling in space results in a larger average distance between pixels, which effectively scales the detectable damage size proportional to CR. Therefore, we can approximate a′ by setting C₁=CR and C₂=0, giving per Eq. 3:

PODᵤ(a)≈POD_{f}(CR×a) (Eq. 3)

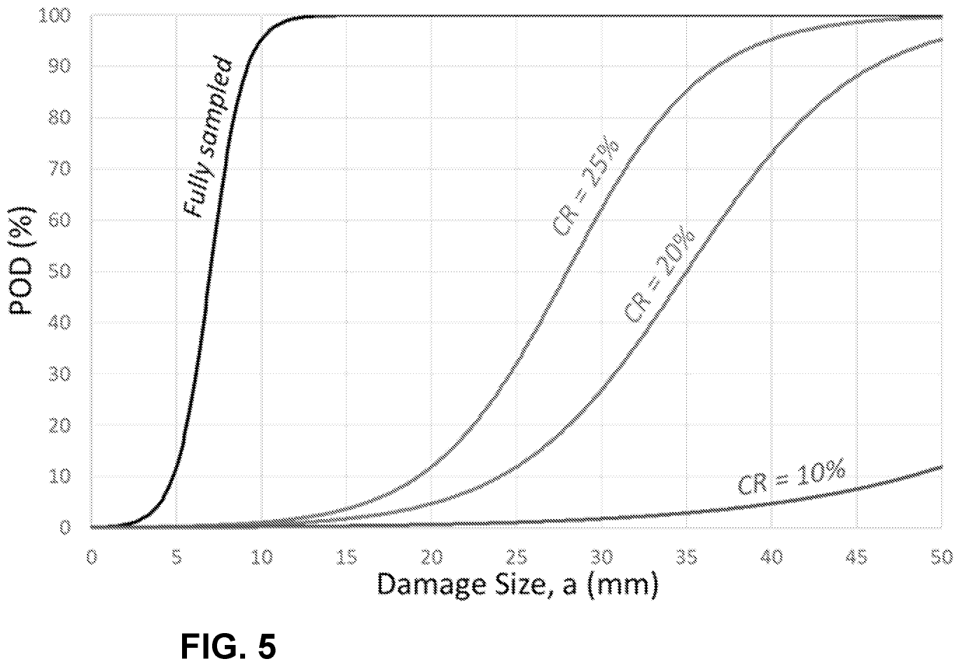

Example POD curves for CR values of 25%, 20%, and 10% are shown in FIG. 5. These values correspond to Z-scan data, and the generated POD curves are before any Compressive Sensing reconstruction of the data. In other words, FIG. 5 graphically illustrates example probability-of-detection (POD) curves for compression ratio (CR) values of 25%, 20%, and 10%, with values corresponding for example Z-scan data, and with generated POD curves before any Compressive Sensing reconstruction of the data in accordance with presently disclosed subject matter.

Applying Compressive Sensing to reconstruct the undersampled data will restore the damage detection capability. The data reconstruction is measured using the correlation coefficient, r. The higher the value of r, the better the reconstruction, and the more the POD curve will move back toward the fully sampled case.

All NDE/SHM systems have an inherent noise level, and two consecutive fully sampled measurements will not be identical to each other due to the inherent noise in the system. The r value between two consecutive fully sampled measurements is the highest r value that a Compressive Sensing reconstruction can achieve, and if it does, then it can be claimed that the data is fully reconstructed, and the POD curve has shifted back to the fully sampled case.

Using a similar formulation as before, the curves for the reconstructed case, PODᵣ, can be expressed per Eq. 4 as:

$${POD}_{r} ( a ) \approx {POD}_{f} ( \frac{{r}_{r}}{r f} \times a ) \qquad ( Eq . 4 )$$

Per Eq. 4, PODᵣ is the POD for the reconstructed data, POD_{f}, is the POD for the fully sampled case, rᵣ is the correlation coefficient for the reconstructed case, and r_{f} is the correlation coefficient between two consecutive fully sampled measurements.

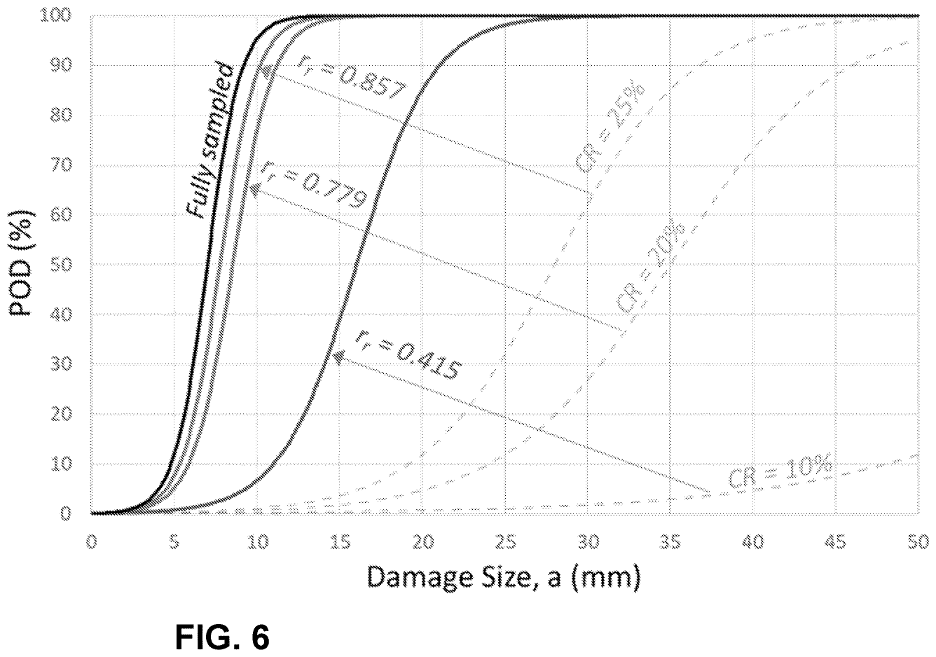

Example POD curves of the Z-scan data after Compressive Sensing reconstructions are shown in FIG. 6. In other words, FIG. 6 graphically illustrates example probability-of-detection (POD) curves, similar to those illustrated per FIG. 5, for compression ratio (CR) values of 25%, 20%, and 10%, with values corresponding for example Z-scan data, but with generated POD curves after Compressive Sensing reconstruction of the data in accordance with presently disclosed subject matter. Here, r_{f}=0.95, and rᵣ=0.857, 0.779, and 0.415 (corresponding to the CR values of 25%, 20%, and 10%, respectively). As can be seen, the reconstructions of the data for the CR=25% and 20% cases nearly restore the POD to the original curve.

Additionally, the disclosed technology includes the following novel features: (1) the ability to generate basis functions needed for Compressive Sensing; (2) the ability to reconstruct temporally undersampled sensor signals from different types of NDE/SHM techniques; (3) the ability to reconstruct parameters from spatially undersampled actuator-sensor paths and/or pixels from images; (4) the ability to generate diagnostic images from the reconstructed data in both time and space; (5) the ability to import and analyze sensor signals from various NDE/SHM techniques and in various data formats; and (6) the ability to quantify the signal/image reconstructions through the use of correlation coefficients and probability-of-detection curves. The advantages of the innovation are the reduction in data acquisition processes and storage, and the potential to reduce the number of required sensors and total weight of NDE/SHM systems.

While certain embodiments of the disclosed subject matter have been described using specific terms, such description is for illustrative purposes only, and it is to be understood that changes and variations may be made without departing from the spirit or scope of the subject matter.

1. Method for generalized compressive sensing process for automated reduction of fully sampled non-destructive evaluation/structural health monitoring (NDE/SHM) data, for use with different types of NDE/SHM systems, comprising:
obtaining fully sampled data by conducting data acquisition relative to a target structure for NDE/SHM;
obtaining undersampled data by applying a selected compression ratio (CR) to the fully sampled data; and
conducting at least one of storing or transmitting the undersampled data.

2. A method according to claim 40, further comprising generating a diagnostic image of the target structure visually indicating any detected structural damage.

3-5. (canceled)

6. A method according to claim 40, further comprising using a compression ratio (CR) value of at least 20%.

7. A method according to claim 40, further comprising using a graphical user interface (GUI) for inputting the fully sampled data, analyzing the reconstructed fully sampled data to detect any structural damage to the target structure, and generating a diagnostic image of the target structure visually indicating any detected structural damage.

8-9. (canceled)

10. A method according to claim 1, wherein conducting data acquisition comprises conducting pitch-catch, ultrasonic guided-wave structural health monitoring (SHM) of the target structure.

11. (canceled)

12. A method according to claim 1, wherein conducting data acquisition comprises obtaining pulse-echo/A-scan data or acoustic emission data of the target structure.

13. (canceled)

14. A method according to claim 1, wherein conducting data acquisition comprises obtaining C-scan data of the target structure.

15. A method according to claim 1, wherein conducting data acquisition comprises at least one of conducting pitch-catch, ultrasonic guided-wave structural health monitoring (SHM) of the target structure, or conducting pulse-echo (A-scan), B-scan, C-scan, Z-scan, acoustic emission, impact data, thermography, or other NDE/SHM techniques.

16. A method according to claim 7, wherein the fully sampled data and the undersampled data are both respectively in a data format including at least one of ASCII, binary, and comma-separated values (CSV) data files.

17. A method according to claim 2, further comprising generating a probability-of-detection (POD) curve as a function of compression ratio (CR), and a determined correlation coefficient (r) after reconstruction to quantify accuracy of damage detection from the reconstructed fully sampled data.

18. Methodology for non-destructive evaluation/structural health monitoring (NDE/SHM) of structures based on pitch-catch ultrasonic guided waves, using a degree of data acquisition from a target structure that is relatively reduced from what is required for a full sampling of the target structure, while maintaining the ability to accurately detect, locate, and characterize damage to the target structure, comprising:
obtaining a set of fully sampled sensor signals from actuator-sensor paths of the target structure;
subjecting the set of fully sampled sensor signals to a selected compression ratio (CR) to obtain undersampled sensor signals;
subjecting the set of undersampled sensor signals to compressive sensing to reconstruct fully sampled sensor signals;
analyzing the reconstructed fully sampled sensor signals to detect any structural damage to the target structure; and
using a graphical user interface (GUI) for inputting the set of fully sampled sensor signals, analyzing the reconstructed fully sampled sensor signals to detect any structural damage to the target structure.

19. Methodology according to claim 18, further comprising generating a diagnostic image of the target structure visually indicating any detected structural damage.

20. Methodology according to claim 18, further comprising generating basis functions for conducting the compressive sensing.

21. Methodology according to claim 18, wherein the a compression ratio (CR) has a value of at least 20%.

22. (canceled)

23. A non-destructive evaluation/structural health monitoring (NDE/SHM) system for generalized compressive sensing process for automated reduction of fully sampled non-destructive evaluation/structural health monitoring (NDE/SHM) data, for use with different types of NDE/SHM data, the system comprising:
a plurality of sensors for data acquisition relative to a target structure; and
one or more tangible, non-transitory computer-readable media that collectively store instructions that, when executed, cause a computing device comprising one or more processors to perform operations, the operations comprising:
obtaining fully sampled data by conducting data acquisition relative to a target structure for NDE/SHM;
obtaining undersampled data by applying a selected compression ratio (CR) to the fully sampled data; and
conducting at least one of storing or transmitting the undersampled data.

24. A non-destructive evaluation/structural health monitoring (NDE/SHM) system according to claim 41, wherein the operations further comprise generating a diagnostic image of the target structure visually indicating any detected structural damage.

25-27. (canceled)

28. A non-destructive evaluation/structural health monitoring (NDE/SHM) system according to claim 41, wherein the operations further comprise using a compression ratio (CR) value of at least 20%.

29. A non-destructive evaluation/structural health monitoring (NDE/SHM) system according to claim 41, wherein the operations further comprise using a graphical user interface (GUI) for inputting the fully sampled data, analyzing the reconstructed fully sampled data to detect any structural damage to the target structure, and generating a diagnostic image of the target structure visually indicating any detected structural damage.

30-31. (canceled)

32. A non-destructive evaluation/structural health monitoring (NDE/SHM) system according to claim 23, wherein conducting data acquisition comprises conducting pitch-catch, ultrasonic guided-wave structural health monitoring (SHM) of the target structure.

33. (canceled)

34. A non-destructive evaluation/structural health monitoring (NDE/SHM) system according to claim 23, wherein conducting data acquisition comprises obtaining pulse-echo/A-scan data or acoustic emission data of the target structure.

35. (canceled)

36. A non-destructive evaluation/structural health monitoring (NDE/SHM) system according to claim 23, wherein conducting data acquisition comprises obtaining C-scan data of the target structure.

37. A non-destructive evaluation/structural health monitoring (NDE/SHM) system according to claim 23, wherein conducting data acquisition comprises at least one of conducting pitch-catch, ultrasonic guided-wave structural health monitoring (SHM) of the target structure, or conducting pulse-echo (A-scan), B-scan, C-scan, Z-scan, acoustic emission, impact data, thermography, or other NDE/SHM techniques.

38. A non-destructive evaluation/structural health monitoring (NDE/SHM) system according to claim 29, wherein the fully sampled data and the undersampled data are both respectively in a data format including at least one of ASCII, binary, and comma-separated values (CSV) data files.

39. A non-destructive evaluation/structural health monitoring (NDE/SHM) system according to claim 24, wherein the operations further comprise generating a probability-of-detection (POD) curve as a function of compression ratio (CR), and a determined correlation coefficient (r) after reconstruction to quantify accuracy of damage detection from the reconstructed fully sampled data.

40. A method according to claim 1, further comprising
using compressive sensing to reconstruct the fully sampled data from the undersampled data; and
analyzing the reconstructed fully sampled data to detect structural damage in the target structure.

41. A non-destructive evaluation/structural health monitoring (NDE/SHM) system according to claim 23, wherein the operations further comprise:
using compressive sensing to reconstruct the fully sampled data from the undersampled data; and
analyzing the reconstructed fully sampled data to detect structural damage in the target structure.
